(19) United States
(12) Patent Application Publication
(10) Pub. No.: US 2012/0166777 A1
(43) Pub. Date: Jun. 28, 2012

(54) METHOD AND APPARATUS FOR SWITCHING THREADS

(75) Inventors: Edward J. McLellan, Holliston, MA (US); Magiting M. Talisayon, Newton, MA (US); Donald A. Priore, Groton, MA (US)

(73) Assignee: ADVANCED MICRO DEVICES, INC., Sunnyvale, CA (US)

(21) Appl. No.: 12/976,034

(22) Filed: Dec. 22, 2010

(51) Int. Cl. G06F 9/30

(52) U.S. Cl. 712/245; 712/E09.016

(57) ABSTRACT

Techniques for switching or parking threads in a processor including a plurality of processor cores that share a microcode engine are disclosed. In a dual-core or multi-core system, a front end, (e.g., microcode engine), of the processor cores may be shared by the two or more active threads in order to reduce the area, cost, or the like. A currently running thread may be put to a sleep state and execution of another thread may be initiated when a yield microcode command issues while the currently thread is running. The thread may be resumed on a condition that the second thread goes to a sleep state, yields, exits the processing, etc. Alternatively, a thread may be put to a sleep state when a sleep microcode command issues which is programmed to occur when the thread needs to wait for an event to occur.

### FIELD OF INVENTION

This application is related to processor multithreading.

### BACKGROUND

In a dual-core or multi-core system, a front end of the processor cores may be shared by the two or more active threads. For example, a microcode engine may be shared by the processor cores. When executing a flow of microcode instructions for multiple threads, the threads contend for the shared resources. When a thread is running on one of the processor cores, there may be a situation that it takes too long to complete the thread but the thread has not reached a point to go into a sleep state. In that situation, the currently running thread would block the other thread.

In a single thread operation, when a thread is waiting for something to happen for some reason, conventionally it just waits in a spin-loop. In a dual-core system that the front end of the core-pair is shared by the active threads, if one of the threads waits in a spin-loop, it would not only block the other thread, but also waste power.

### SUMMARY OF EMBODIMENTS

Embodiments for switching or parking threads in a processor including a plurality of processor cores that share a microcode engine are disclosed. In a dual-core or multi-core system, a front end, (e.g., microcode engine), of the processor cores may be shared by the two or more active threads in order to reduce the area, cost, or the like. A currently running thread may be put to a sleep state and execution of another thread may be initiated when a yield microcode command issues while the currently thread is running. The thread may be resumed on a condition that the second thread goes to a sleep state, yields, exits the processing, etc. Alternatively, a thread may be put to a sleep state when a sleep microcode command issues which is programmed to occur when the thread needs to wait for an event to occur.

### BRIEF DESCRIPTION OF THE DRAWINGS

A more detailed understanding may be had from the following description, given by way of example in conjunction with the accompanying drawings wherein:

FIG. 1 shows a structure of an example processor;

FIG. 2 shows portions of the processor core and illustrates the flow of instructions through the processor core;

FIG. 3 is a flow diagram of an example process for switching threads in accordance with one embodiment; and

FIG. 4 is a flow diagram of an example process for parking a thread in accordance with one embodiment.

### DETAILED DESCRIPTION OF EMBODIMENTS

The embodiments will be described with reference to the drawing figures wherein like numerals represent like elements throughout.

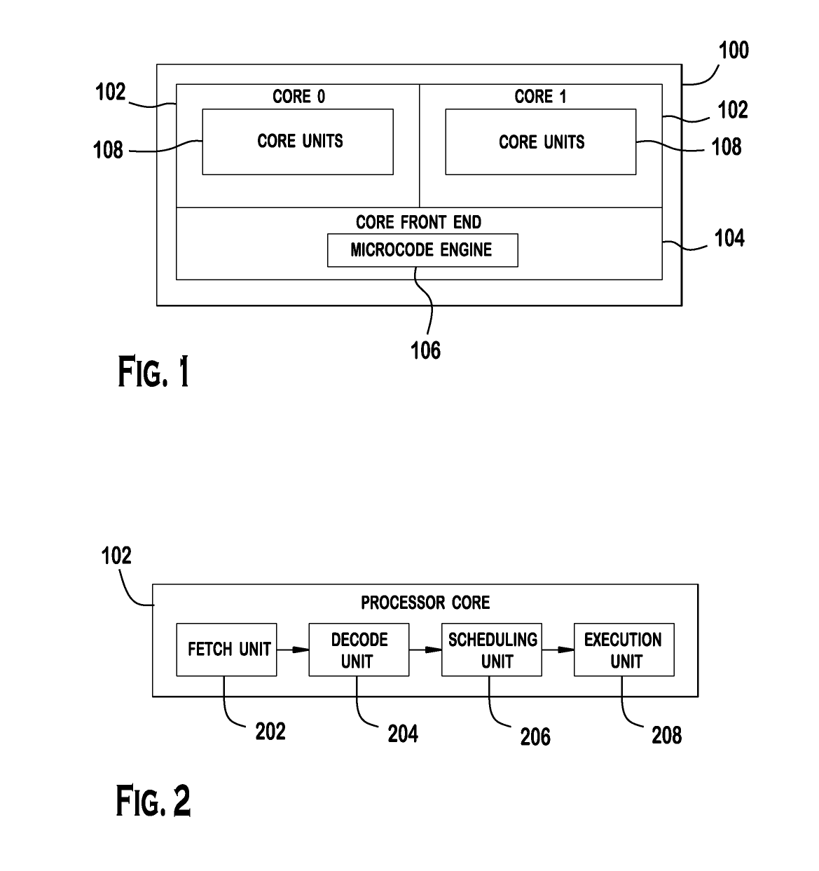

FIG. 1 shows a structure of an example processor 100. As used hereafter, the term “processor” is intended to refer to any type of processing unit including a microprocessor, a central processing unit (CPU), a graphics processing unit (GPU), a combination thereof, and the like. The processor 100 may include a plurality of processor cores 102 and a front end 104 shared by the processor cores 102. Each processor core 102 includes core units 108, which can include, for example, a fetch unit, a decode unit, a scheduling unit, an execute unit, a retire unit, and the like. The front end 104 may include a microcode engine 106, etc. The processor 100 may also include a cache(s) for storing instructions and/or data, a routing unit for communicating between the processor cores 102 and other various components of the system, or other components (not shown). It should be noted that FIG. 1 is provided as an example, not as a limitation, and even though it is depicted that the processor 100 includes two processor cores, the embodiments disclosed herein are applicable to a processor with any number of cores or a system with multiple processors with single or multiple cores.

FIG. 2 shows portions of the processor core 102 and illustrates the flow of instructions through the processor core 102. The processor core 102 may include a fetch unit 202, a decode unit 204, a scheduling unit 206, and an execution unit 208. The fetch unit 202 fetches instructions to be decoded by the decode unit 204. The instructions may be fetched from a memory. The decode unit 204 decodes the fetched instructions. For example, the decode unit 204 may decode the fetched instructions into a plurality of micro-operations. The scheduling unit 206 performs various operations associated with storing decoded instructions and issuing the decoded instructions to the execution unit 208. The execution unit 208 executes the dispatched decoded instructions. The execution unit 208 may also execute a flow of microcode commands issued from the microcode engine 106.

When executing a flow of microcode commands for threads, the microcode engine 106 issues a sequence of microcode commands to one of the processor cores 102 for execution. A microcode commands are picked from a control store by a microcode sequencer based on a counter and/or data from the instruction register or the control store. With the dual core with the shared front end, (i.e., one microcode engine is shared by the two threads), one thread may be running at a given time. A new thread may be selected for running after completion of the currently running thread if there is a task available for the new thread. However, in that case if the thread needs to execute a long flow of microcode commands, it would completely block the other thread and may cause performance or fairness problems.

In accordance with one embodiment, a new microcode command (.yield) is added to the microcode sequencer to switch to another thread while the currently operating thread is running. For example, the yield microcode command may be programmed in the middle of a thread that needs to execute a long flow of microcode commands. When the yield command issues, the microcode sequencer switches from the currently running thread to another thread to provide an opportunity to run to another thread while retaining information for the currently running thread so that it can resume that thread later. The thread may be resumed when the other thread yields, goes to a sleep state, exits the processing, or the like.

By using an explicit microcode command, the microcode may program precisely where the thread switch may occur if there is a task available on the other thread. For example, the yield microcode command may be programmed to occur on a specific operation such as a microcode synchronization stall so a second thread may begin processing while the currently running thread begins a programmed stall period. In this case, the yield operation may occur at known times within the microcode flow.

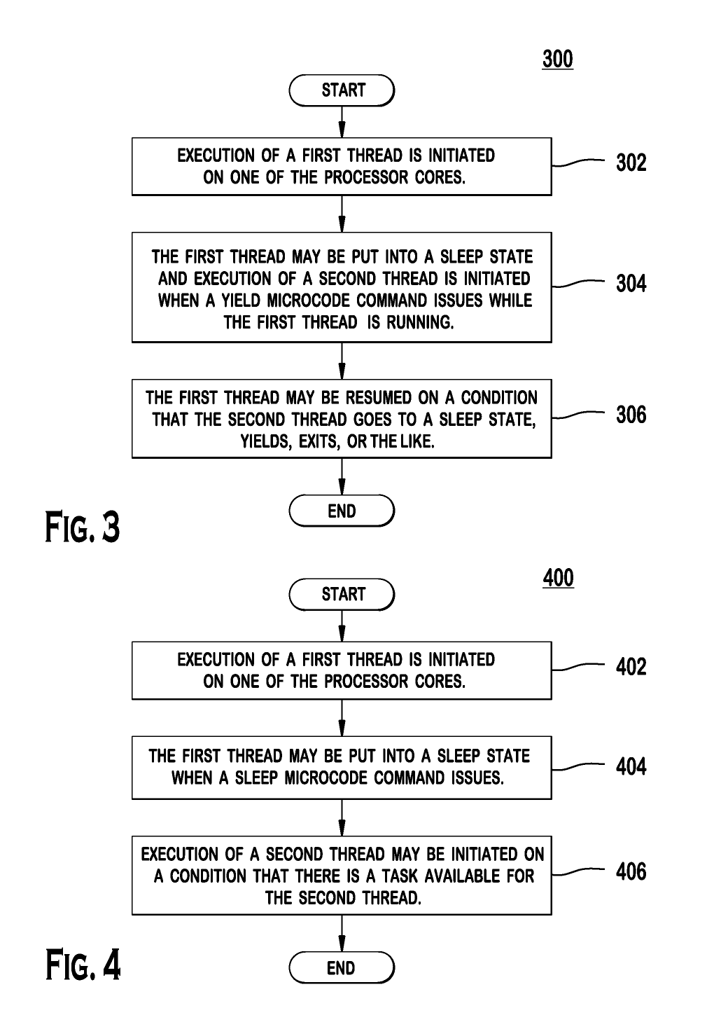

FIG. 3 is a flow diagram of an example process for switching threads in accordance with one embodiment. Execution of a first thread is initiated on one of the processor cores (302). The first thread may be put into a sleep state and execution of a second thread is initiated when a yield microcode command issues while the first thread is running (304). The first thread may be resumed on a condition that the second thread goes to a sleep state, yields, exits the processing, or the like (306).

With this embodiment, the thread that needs to execute a long flow of microcode commands may not completely block the other thread causing potential performance or fairness problems.

Threads often have to wait for a certain event(s) to occur before continuing to execute, such as waiting for availability or release of a resource, an external event (e.g., an interrupt), or an expiration of a timer, etc. While a thread is waiting for an event to occur, conventionally the thread just waits in a spin-loop. In a multi-core system with the shared front end, (e.g., microcode engine), if one of the threads waits in a spin-loop waiting for an event to occur, it not only blocks the other thread from running, but also wastes a power.

In accordance with one embodiment, a new microcode command (.sleep) is added to the microcode sequencer to “park” the currently running thread into a sleep state when the currently running thread needs to wait for an event to occur so as not to block the other thread and waste power. The microcode sequencer may hold the pending interrupt(s). The information for the currently running thread is retained so that it can be resumed when the event occurs. After parking the thread, another thread may begin executing if there is a task available for that thread.

The thread in the sleep state requires an interrupt to restart. The microcode engine 106 may send a signal through the pipeline so that the execution units in the processor cores 102 know that the thread is on a sleep state. Once the event occurs, the execution unit may send a signal (e.g., microRedirect) to the microcode engine 106 to restart the sleeping thread.

FIG. 4 is a flow diagram of an example process for parking a thread in accordance with one embodiment. Execution of a thread is initiated on one of the processor cores (402). The thread may be put into a sleep state when a sleep microcode command issues (404). The sleep microcode command is programmed to occur when the first thread needs to wait for an event to occur. Execution of a second thread may be initiated on a condition that there is a task available for the second thread (406).

With this embodiment, the thread that waits for an external event may not block other threads, and does not waste power just spinning in a loop waiting for some external event. Use of the sleep command allows optimization of the sleep state where power can be reduced to a minimal level within the processor. It also offers a low power state with very rapid return to processing.

Although features and elements are described above in particular combinations, each feature or element may be used alone without the other features and elements or in various combinations with or without other features and elements. The apparatus described herein may be manufactured by using a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data (e.g., netlists, GDS data, or the like) that may be used to perform a manufacturing process implemented in a semiconductor fabrication facility. The manufacturing process may be adapted to manufacture semiconductor devices (e.g., processors) that embody various aspects of the present invention.

Suitable processors include, by way of example, a general purpose processor, a special purpose processor, a conventional processor, a digital signal processor (DSP), a plurality of microprocessors, a graphics processing unit (GPU), a DSP core, a controller, a microcontroller, application specific integrated circuits (ASICs), field programmable gate arrays (FPGAs), any other type of integrated circuit (IC), and/or a state machine, or combinations thereof.

What is claimed is:

1. A processor comprising:
a plurality of processor cores; and
a microcode engine for issuing a sequence of microcode commands to one of the processor cores, the microcode engine being shared by the processor cores, wherein the microcode engine is configured to put a first thread to a sleep state and initiate execution of a second thread when a yield microcode command issues while the first thread is running.

2. The processor of claim 1 wherein the microcode engine is configured to resume the first thread on a condition that the second thread goes to a sleep state.

3. The processor of claim 1 wherein the microcode engine is configured to resume the first thread on a condition that the second thread yields to the first thread.

4. The processor of claim 1 wherein the microcode engine is configured to resume the first thread on a condition that the second thread exits processing.

5. The processor of claim 1 wherein the microcode engine is configured to put the first thread to a sleep state when the first thread begins a programmed stall period for microcode synchronization.

6. A processor comprising:
a plurality of processor cores; and
a microcode engine for issuing a sequence of microcode commands to one of the processor cores, the microcode engine being shared by the processor cores, wherein the microcode engine is configured to put a first thread to a sleep state when a sleep microcode command issues which is programmed to occur when the first thread is waiting for an event to occur.

7. The processor of claim 6 wherein the microcode engine is configured to resume the first thread on a condition that the microcode engine receives an interrupt signal indicating an occurrence of the event.

8. The processor of claim 6 wherein the event includes at least one of availability or release of a resource, occurrence of an external event, or an expiration of a timer.

9. The processor of claim 6 wherein the microcode engine is configured to initiate execution of a second thread on a condition that there is a task available for the second thread.

10. A method for switching threads in a processor including a plurality of processor cores that share a microcode engine, the method comprising:
initiating execution of a first thread; and
putting the first thread to a sleep state and initiating execution of a second thread when a yield microcode command issues while the first thread is running.

11. The method of claim 10 further comprising:
resuming the first thread on a condition that the second thread goes to a sleep state.

12. The method of claim 10 further comprising:
resuming the first thread on a condition that the second thread yields.

13. The method of claim 10 further comprising:
resuming the first thread on a condition that the second thread exits processing.

14. The method of claim 10 wherein the first thread is put to a sleep state when the first thread begins a programmed stall period for microcode synchronization.

15. A method for parking a thread in a processor including a plurality of processor cores that share a microcode engine, the method comprising:
issuing, by a microcode engine, a sequence of microcode commands for initiating execution of a first thread;
putting the first thread to a sleep state when a sleep microcode command issues which is programmed to occur when the first thread is waiting for an event to occur.

16. The method of claim 15 further comprising:
resuming the first thread on a condition that the microcode engine receives an interrupt signal indicating an occurrence of the event.

17. The method of claim 15 wherein the event includes at least one of availability or release of a resource, occurrence of an external event, or an expiration of a timer.

18. The method of claim 15 further comprising:
initiating execution of a second thread on a condition that there is a task available for the second thread.
